(19) United States
(12) Patent Application Publication
(10) Pub. No.: US 2014/0078344 A1
(43) Pub. Date: Mar. 20, 2014

(54) DEVICE AND METHOD PROCESSING CONTINUOUS SHOOTING IMAGE DATA

(71) Applicants: SONG HO YOON, YONGIN-SI (KR); JEONG UK KANG, BUCHEON-SI (KR); WOON JAE CHUNG, GUNPO-SI (KR)

(72) Inventors: SONG HO YOON, YONGIN-SI (KR); JEONG UK KANG, BUCHEON-SI (KR); WOON JAE CHUNG, GUNPO-SI (KR)

(21) Appl. No.: 14/025,963

(22) Filed: Sep. 13, 2013

(30) Foreign Application Priority Data
Sep. 14, 2012 (KR) 10-2012-0102471

(51) Int. Cl. H04N 5/77

(52) U.S. Cl. CPC H04N 5/772
USPC 348/231.99

(57) ABSTRACT

An image processing system includes a host that generates continuous shooting image data (CSID), and a flash storage device including a memory cell array including a first memory region and a second memory region. A portion of the first memory region is a dedicated CSID buffer region that temporarily stores only CSID. The second memory region stores normal data provided to the flash storage device by the host during a normal program operation. The first memory region supports data access operations including the normal program operation performed at a first speed, and the second memory region supports data access operations performed at a second speed slower than the first speed.

### CROSS-REFERENCE TO RELATED APPLICATIONS

This application claims priority under 35 U.S.C. §119(a) from Korean Patent Application No. 10-2012-0102474 filed on Sep. 14, 2012, the subject matter of which is hereby incorporated by reference.

### BACKGROUND

The inventive concept relates to devices and methods capable of processing continuous shooting image data (CSID). More particularly, the inventive concept relates to devices and methods capable of real-time processing and storing CSID generated by high-resolution continuous shooting functions in a nonvolatile storage device regardless of a particular data storage capacity (or available data storage capacity) of a constituent random access memory.

Many contemporary mobile devices such as smart phones, tablet personal computers (PCs), and digital cameras include a Random Access Memory (RAM) that is used during the execution of applications and operating systems, a nonvolatile storage device that is used to store user data, and a camera module that is capable of generating image data (i.e., still image data and/or continuous shooting image data). As the number of camera pixels included in the camera module increases, image resolution increases. A greater number of pixels also supports improved continuous shooting functions.

Contemporary mobile devices supporting continuous shooting function(s) typically store the CSID generated by the continuous shooting function in a dedicated portion of RAM. Then, the CSID stored in RAM is copied to the nonvolatile storage device once the dedicated portion of RAM is full. Such mobile devices repeat this 2-step approach (i.e., first filling a dedicated portion of RAM, and then moving the CSID stored in RAM to the nonvolatile memory) because the RAM may be operated in a write mode that is sufficiently fast to store the CSID in RAM within given time constraints. However, write modes available for contemporary nonvolatile storage devices are too slow to meet similar time constraints.

Unfortunately, the size of the dedicated portion of RAM allocated to CSID storage, as well as the write block size for the CSID being stored in the RAM and the corresponding number of continuous shooting images that may be captured by a particular image processing system are all restricted. For example, it has become impractical to many instances to increase the size of the dedicated portion of RAM allocated to CSID storage because certain applications executed by mobile devices during (or in relation to) a continuous shooting function also demand considerable memory space in RAM. In other conventional instances, when the data storage capacity of the RAM is exceeded by extended continuous shooting operations, either the continuous shooting operation must be halted, or the resolution of the resulting CSID is degraded.

### SUMMARY

An embodiment of the inventive concept provides a method for operating a flash storage device in an image processing system during execution of multiple continuous shooting (CS) operations that respectively generate CS image data (CSID), wherein a memory array of the flash storage device includes a first memory region and a second memory region, the method comprising; receiving region allocation information (RAI) from a host, allocating in response to the RAI a portion of the first memory region as a dedicated CSID buffer region used to temporarily store only CSID during execution of the CS operations, and allocating a portion of the second memory region as a normal data region used to store normal data during a normal program operation, wherein the first memory region is configured to support data access operations including the normal program operation performed at a first speed, and the second memory region is configured to support data access operations performed at a second speed slower than the first speed.

Another embodiment of the inventive concept provides an image processing system comprising; a host that generates continuous shooting image data (CSID) and a flash storage device including a memory cell array including a first memory region and a second memory region. A portion of the first memory region is a dedicated CSID buffer region that temporarily stores only CSID, and the second memory region stores normal data provided to the flash storage device by the host during a normal program operation. The first memory region supports data access operations including the normal program operation performed at a first speed, and the second memory region supports data access operations performed at a second speed slower than the first speed.

### BRIEF DESCRIPTION OF THE DRAWINGS

FIG. 1 is a block diagram illustrating an image processing device capable of performing a continuous shooting operation according to embodiments of the inventive concept;

FIG. 2 is a block diagram further illustrating the flash storage device of FIG. 1;

FIG. 3 is a flowchart summarizing one approach to performing a continuous shooting operation according to embodiments of the inventive concept;

FIG. 4 is an operating diagram illustrating one example of the initialization step S100 in the method of FIG. 3;

FIG. 5 is a flowchart summarizing one example of the performing a continuous shooting operation step S200 of the method of FIG. 3;

FIG. 6 is a flowchart summarizing one example of the performing a migration operation step S300 of the method of FIG. 3;

FIG. 7 is a flowchart summarizing another example of the performing a migration operation step S300 of the method of FIG. 3

FIG. 8 is a flowchart summarizing one more particular example of the migration of CSID to the second memory step S320 of the methods of FIGS. 6 and 7;

FIG. 9 is a block diagram illustrating one approach to address mapping that may be performed after a continuous shooting operation; and

FIG. 10 is a block diagram illustrating another approach to address mapping that may be performed after a migration operation.

### DETAILED DESCRIPTION

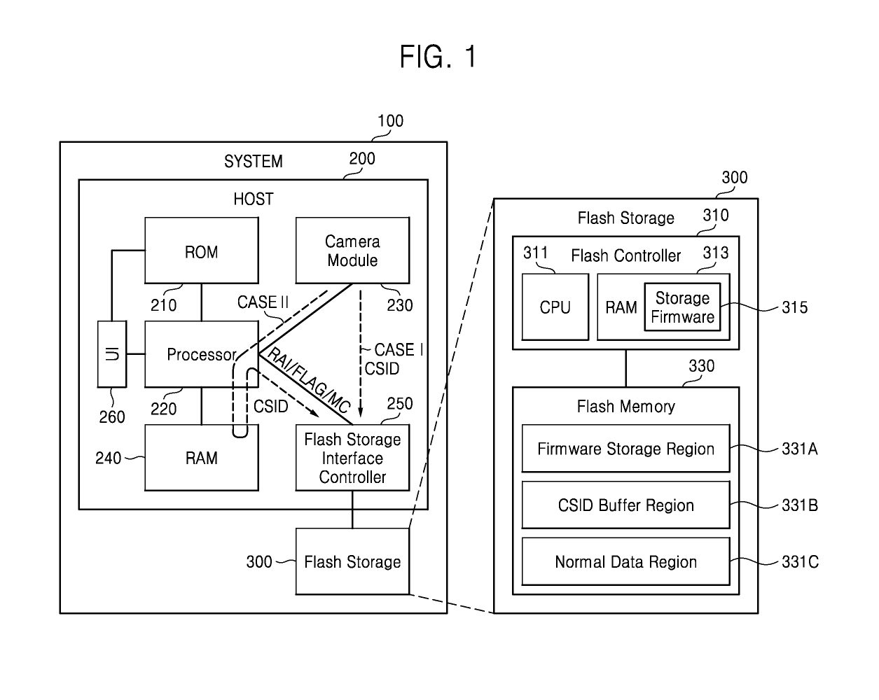

FIG. 1 is a block diagram of an image processing system 100 capable of operating in one or more continuous shooting (CS) mode(s) of operation according to certain embodiments of the inventive concept. The image processing system 100 generally comprises a host 200 and a flash storage device 300. The image processing system 100 may be embodied within, or as part of, a personal computer (PC), laptop computer, smart phone, tablet PC, digital camera, etc.

In various configurations, the host 200 may be operated in one or more CS modes that generate “continuous shooting image data” or “CSID.” Examples of CS modes include burst mode, multi-shot mode, continuous video mode, etc. In certain embodiments of the inventive concept, the CSID generated by the host 200 while operating in a CS mode may be communicated on-the-fly to the flash storage device 300. In this context, the term “on-the-fly” will be understood by those skilled in the art as denoting data processing approaches that immediately process data as it is generated in real time.

In relevant portion, the host 200 comprises a read only memory (ROM) 210, a processor 220, a camera module 230, a random access memory (RAM) 240, a flash storage device interface controller 250, and a user interface (UI) 260. In certain embodiments of the inventive concept, the host 200 may be embodied using system-on-chip (SoC) fabrication techniques.

During a CS mode, the camera module 230 may variously be used to generate CSID.

The ROM 210 may be used to store data defining one or more application(s), related files and/or operating systems (OS), or host firmware necessary to control the operation of the host 200. The OS and/or host firmware may be executed under the control of the processor 220 after being loaded from the ROM 210 to the RAM 240. The ROM 210 may be implemented using one or more non-volatile memory device(s).

As instructed by the OS and/or host firmware, the processor 220 may be used to control operation of the camera module 230, and inter-operation of the camera module 230 with RAM 240, flash storage device interface controller 250, and UI 260.

According to certain embodiments of the inventive concept, the RAM 240 may be implemented using volatile memory, such as a dynamic RAM (DRAM), a static RAM (SRAM), a thyristor RAM (T-RAM), a zero capacitor RAM (Z-RAM), a Twin Transistor RAM (TTRAM) and similar. In the illustrated embodiment of FIG. 1, it is assumed that the RAM 240 is a DRAM capable of buffering CSID on-the-fly.

During initialization of a CS mode, the processor 220 may be used to generate “region allocation information” (RAI) that is communicated to the flash storage device 300 via the flash storage device interface controller 250. The RAI will typically include at least one of; a defined image resolution, a CS frame rate, and a CS time. In certain embodiments of the inventive concept, the RAI may include a CSID buffer region size or a CSID buffer region size value. Particular RAI may be predetermined by a manufacturer of the image processing system 100 or a constituent host incorporating the image processing system 100), or it may defined in accordance with user inputs communicated to the image processing system 100 via the UI 260. The provision and use of RAI will be described in some additional detail hereafter.

In certain embodiments of the inventive concept, the host 200 additionally includes an integral display (not shown in FIG. 1) that may be used to display at least a portion of the UI 260. The display may be conventionally embodied using a thin film transistor-liquid crystal display (TFT-LCD), a light emitting diode (LED) display, an organic LED (OLED) display, an active-matrix OLED (AMOLED) display, or a flexible display.

During a CS mode, the processor 220 may be used to generate a CSID flag (FLAG) indicating that the particular data being communicated by the processor 220 to the flash storage device 300 is CSID. Additionally, after (or near) termination of a CS mode, the processor 220 may be used to generate a migration command (MC), wherein the MC is communicated via the flash memory interface controller 250 to the flash storage device 300. In this regard, the MC may be communicated separately or in conjunction with the CSID flag, and/or RAI. When received by the flash memory interface controller 250, the MC is interpreted to secure or “allocate” a region in the flash storage device 300 dedicated to the storing of CSID (hereafter, “the CSID region).

In a first assumed case (CASE I), CSID provided by the camera module 230 is directly communicated from the camera module 230 to the flash storage device 300 via the flash storage device interface controller 250. However, in a second assumed case (CASE II), CSID provided by the camera module 230 is indirectly communicated to the flash storage device 300 via the flash storage device interface controller 250 after being intermediately buffered in the RAM 240. The buffered CSID may then be provided from the RAM 240 to the flash storage device 300 via and flash storage device interface controller 250 under the control of the processor 220.

In either CASE I or CASE II, an image processing system with embodiments of the inventive concept may be used to store CSID in a nonvolatile memory device on-the-fly and at relatively high data processing speeds. That is, the host 200 of FIG. 1 may store CSID in the flash storage device 300 on-the-fly using the processor 220 and the flash storage device interface controller 250 without waiting until some portion of the RAM 240 used to store CSID is completely filled. As a result, the host 200 may process and store the CSID provided by the camera module 230 in the flash storage device 300 on-the-fly regardless of the particular CSID data storage capacity provided by the RAM 240. Accordingly, the ability of the host 200 to operate in a given CS mode and with a given data resolution is not inherently limited by the data storage capacity, or available data storage capacity of the RAM 240. This result compares quite favorably with conventional approaches to the provision of CS modes of operation for certain data processing systems that are constrained in their data processing capabilities by the use of and the size of the RAM 240. Thus, image processing systems like the one shown in FIG. 1 according to embodiments of the inventive concept provide a user with more enjoyable CS mode functionality.

In the description that follows, it is assumed that the host 200 of FIG. 1 may be selectively operating in ether one of first and second modes respectively corresponding to CASE I and CASE II described above. However, this need not always be so since other embodiments of the inventive concept may provide a data processing system capable of operating in only one of the first and second modes.

Returning to the illustrated embodiment of FIG. 1, the flash storage device interface controller 250 is used to communicate “write data” during write operations and “read data” during read operations between the flash storage device 300 and the host 200. In addition, the flash storage device interface controller 250 may also be used to communicate CSID, RAI, CSID flag, and/or MC from the processor 220 to the flash storage device 300 (CASE II), and to communicate CSID from the camera module 230 to the flash storage device 300 (CASE I).

In certain embodiments of the inventive concept, the data processing system 100 allows a user via the UI 260 to input one or more “resolution parameters” (e.g., an image resolution, a CS frame rate, and/or a CS time). Alternately, one or more resolution parameters may be pre-set by the manufacturer of the data processing system 100. In either event, the processor 220 may be used to generate the RAI according to one or more resolution parameter(s).

The flash storage device 300 may be variously embodied as will be understood by those skilled in the art. The flash storage device 300 may be physically embedded (or integrated) within the image processing system 100, or it may be provided in a manner that allows physical attachment/detachment with the image processing system 100 (e.g., an embedded multimedia card (eMMC)). In certain embodiments of the inventive concept, the flash storage device 300 may be a solid state drive (SSD), universal flash storage (UFS) a secure digital (SD) card, a Universal Serial Bus (USB) flash drive, a subscriber identification module (SIM) card, or a Universal Subscriber Identity Module (USIM) card.

A flash memory type storage device has been assumed for the illustrated embodiment of FIG. 1, but other types of storages devices may be used instead of or on addition to flash memory. For example, the flash storage device 300 of FIG. 1 might may be replaced with a different type of Electrically Erasable Programmable Read-Only Memory (EEPROM), a Magnetic RAM (MRAM), a Spin-Transfer Torque MRAM, a Conductive bridging RAM (CBRAM), a Ferroelectric RAM (FeRAM), a Phase change RAM (PRAM), a Resistive RAM (RRAM or ReRAM), a Nanotude RRAM, a Polymer RAM (PoRAM), a Nano Floating Gate Memory (NFGM), a holographic memory, a Molecular Electronics Memory Device, or an Insulator Resistance Change Memory.

As will be described in some additional detail hereafter, the flash storage device 300 may include flash memory cells conventionally arranged in one or more memory cell array(s). The constituent memory cells may be accessed using single level data techniques and/or multi-level data techniques according to designated region(s) within the memory cell array. Thus, the flash storage device 300 in various embodiments of the inventive concept may be said to include single level memory cells (SLC) and/or multi-level memory cells (MLC) such as triple level cells (TLCs) and/or quad level cells (QLCs).

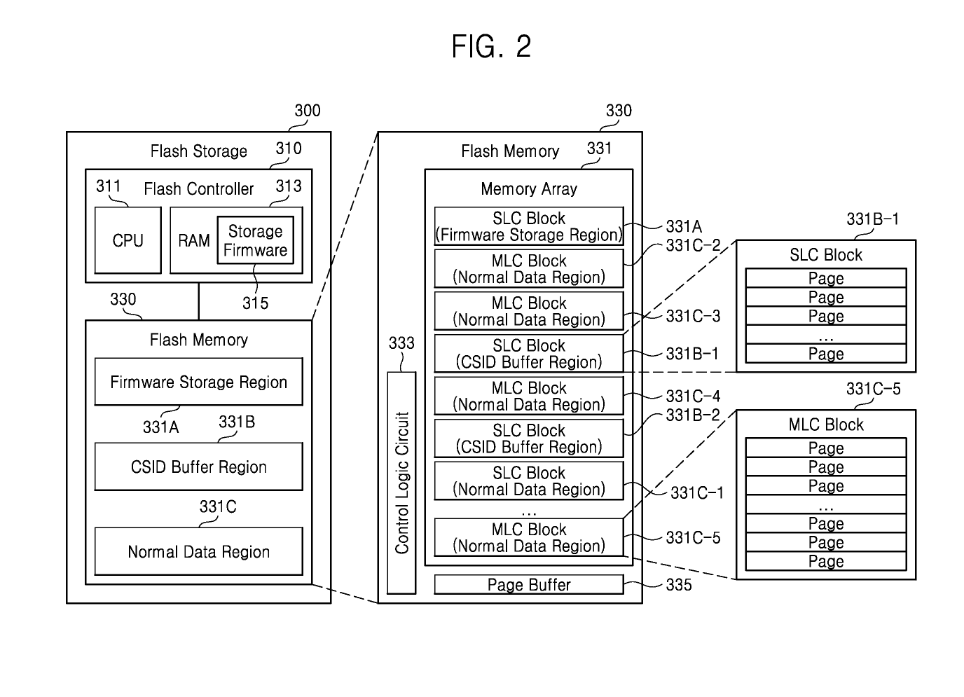

FIG. 2 is a block diagram further illustrating the flash storage device 300 of FIG. 1. Referring to FIGS. 1 and 2, the flash storage device 300 generally comprises a flash controller 310 and flash memory 330.

During a CS mode, the flash controller 310 may be used, for example, to control the definition and allocation of various memory region(s) within a memory cell array 331, storage of CSID, and execution of a migration operation invoked by receipt of a MC. In this regard, the flash controller 310 may be used to interpret a migration command MC received from the host 200 and control the execution of a corresponding migration operation by flash memory 330. That is, the flash controller 310 may be used to monitor a “nominal CSID period” during which CSID is stored in an allocated CSID memory region. In this manner, the flash controller 310 may control execution of a migration operation in accordance with a nominal CSID time period.

In the embodiment illustrated in FIG. 2, the flash controller 310 generally includes a Central Processing Unit (CPU) 311 and a RAM 313. The CPU 311 controls the overall operation of the flash storage device 300 as instructed (e.g.,) by software resident in (e.g.,) ROM 210 of FIG. 1 and/or flash memory 330 but loaded for execution to RAM 313 as firmware 315. The flash memory 330 of FIG. 1 comprises in addition to the memory array 331, a control logic circuit 333, and a page buffer 335.

In the embodiment illustrated in FIG. 2, the flash memory 330 includes memory space particularly designated (or allocated) as a nonvolatile firmware storage region 331A, a CSID buffer region 331B, and a normal data region 331C. In certain embodiments of the inventive concept, the firmware storage region 331A and the CSID buffer region 331B may each include SLC. In contrast, the normal data region 331C may include SLC and/or MLC. Hence, the data access speed (e.g., programming speed) for the firmware storage region 331A and the CSID buffer region 331B will be relatively faster than a data write speed for the normal data region 331C. In this regard, the firmware storage region 331A and the CSID buffer region 331B form a first memory region of the flash memory 330 capable of supporting data access operations executed at a first speed, and the normal data region 331C forms a second memory region of the flash memory 330 capable of supporting data access operations executed at a second speed, wherein the first speed is faster than the second speed.

Thus, consistent with the illustrated embodiment of FIG. 2, at least some portion of the first memory region will be allocated and operatively designated as a CSID buffer region dedicated to the storage only CSID. In contrast, the second memory region may be used to store “normal data” (e.g., user-defined data, payload data, etc.) generated during normally performed read and write operations.

As illustrated in FIG. 2, each one of the firmware storage region 331A, CSID buffer region 331B and normal data region 331C may include one or more allocated memory blocks, wherein each memory block includes either SLC or MLC according to the constituent nature of the allocated-to region.

The storage firmware 315 being executed by the flash controller 310 may be used to interpret a RAI received from the host 200. In response to the RAI, the flash controller may allocate one or more blocks (e.g., 331A, 331B-1, 331B-2, and 331C-1 through 331C-5) to each designated region of the flash memory 330. Here, for example, blocks 331A, 331B-1 and 331B-2 are assumed to be blocks including SLC configured to support access operations executed at a relatively fast speed. Accordingly, the flash controller 310 allocates the block 331A to the firmware storage region 331A, and allocates blocks 331B-1 and 331B-2 to the dedicated CSID buffer region. In contrast, the flash controller 310 allocates blocks 331C-1 through 331C-5, including MLC configured to support access operations executed at a relatively slow speed, to the normal data region 331C.

As further illustrated in FIG. 2, each SLC block and each MLC block will usually include a number of pages. In certain embodiments, a particular page is formed by memory cells (SLC or MLC) arranged along a common word line. In certain embodiments of the inventive concept, the term “block” or “memory block” denotes a defined erase unit, and the term “page” denotes a write (program) unit and a read unit for the flash memory device 330.

Under the control of the flash controller 310, the control logic circuit 333 may be used to control execution of data access operation (e.g., read, write (program) and/or erase operations) directed to selected memory cells of the flash memory 330. The page buffer 335 may be used to program data (i.e., normal write data or CSID) received from the host 200 in either the first memory region or the second memory region of the flash memory 330 depending on the data type and/or the type of operation being executed.

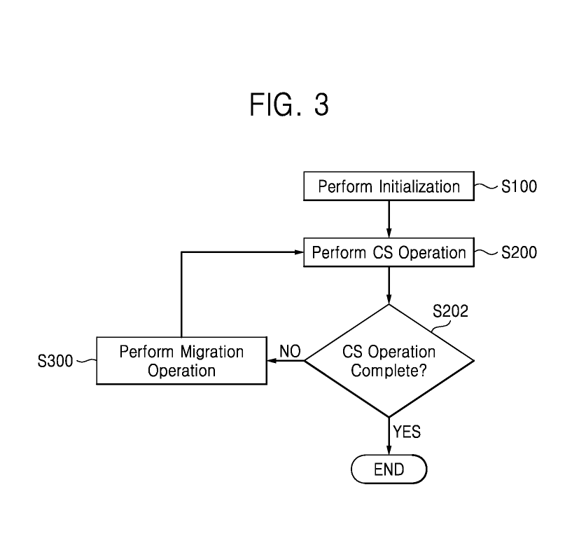

FIG. 3 is a general flowchart summarizing one possible approach to the execution of a continuous shooting (CS) operation by the image processing system 100 of FIG. 1 according to certain embodiments of the inventive concept. The method of FIG. 3 comprises: performing an initialization operation for the image processing system 100 (S100); then performing a CS operation (S200); and for so long as the CS operation is being performed (S202=NO), performing a migration operation (S300), otherwise (S202=YES) ending. Operative examples for each one of these steps will be further described by way of corresponding embodiment(s) hereafter.

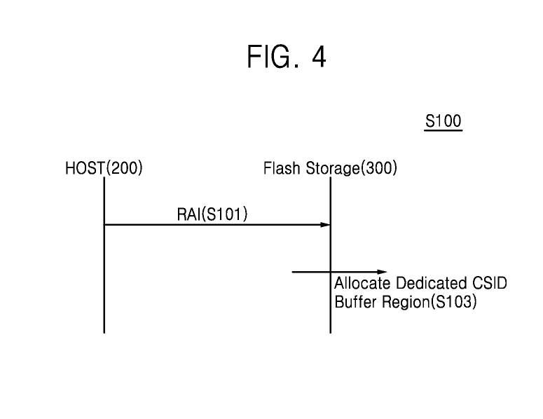

FIG. 4 is an operating diagram illustrating initialization of the image processing system 100 during a CS operation (S100 in FIG. 2). Referring to FIGS. 1, 2, 3 and 4, the image processing system 100 performs initialization (S100) by communicating a region allocation information (RAI) from the processor 220 to the flash controller 310 via the flash storage device interface controller 250 (S101). In response, the firmware 315 running on the flash controller 310 interprets the received RAI, and allocates one or more memory blocks of SLC to a dedicated CSID buffer region (S103).

For example, assuming a given image resolution of 8 Mbytes per frame, a CS frame rate of 10 frames per second, and a CS time is 2 seconds as resolution parameters communicated by the RAI, the flash controller 310 must allocate a minimum of 160 Mbytes (or 8 Mbytes×10/s×2 s) for the dedicated CSID buffer region intended to store CSID (S103).

When received, the RAI may be stored in a register or defined location in flash memory 330. However, when the flash storage device 300 is assumed to be an eMMC having an extended card specific data register (EXT_CSD register) according to certain embodiments of the inventive concept, the RAI may be stored in the conventionally understood VENDOR_SPECIFIC_FIELD of the EXT_CSD register in accordance with a SWITCH command provided by the host 200. Hence, the dedicated CSID buffer region may be allocated in accordance with certain region allocation information (RAI) stored in the flash memory 330 or in accordance with the VENDOR_SPECIFIC_FIELD field of an EXT_CSD register. In this regard, those skilled in the art will understand that various Joint Electron Devices Engineering Council (JEDEC) standards are available that characterize and/or define the structure, constitution and/or operating conditions of eMMCs. These standards may be readily obtained and consulted by recourse to http://www.jedec.org. For example, the embedded multimedia card (eMMC) electrical standard, version 4.51 published June 2012 (i.e., JESD84-B451) contains many terms and technical definitions that are useful to an understanding of certain embodiments of the inventive concept incorporating an eMMC.

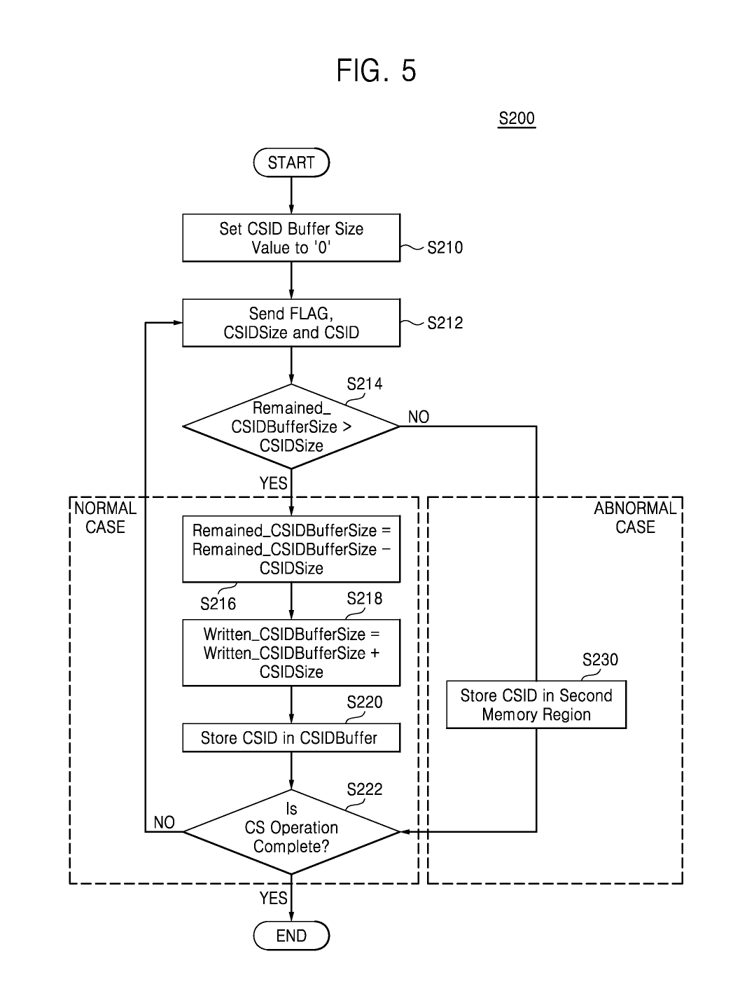

FIG. 5 is a flowchart summarizing one possible approach to the storing of CSID during execution of a CS operation by the image processing system of FIG. 1. Referring to FIGS. 1, 2, 3 and 5, once a CS operation starts, a “CSID buffer region size value” defining the current size of the dedicated CSID buffer region in flash memory 330 is set to ‘0’ (S210).

The host 200 may then send the CSID flag (FLAG) indicating that the data being communicated is, in fact, CSID. The host 200 may also send a CSID size value (CSIDSize) defining the size of the CSID along with the CSID to be stored in the CSID buffer region of the flash memory 330 (S212).

Upon receiving the CSID flag, the CSID size value, and the CSID, the flash controller 310 will control operation of the flash memory 330 in such a manner that a “CSID write operation” is executed for the CSID in accordance with the received CSID size value in the dedicated CSID region. To execute the CSID write operation, the flash memory controller 310 may first determine whether a currently calculated, remaining CSID buffer region value (Remained_CSIDBufferSize) indicating the size of the remaining memory space in the CSID buffer region is greater than the received CSID size value (S214). If not (S214=NO) and the remaining memory space in the CSID buffer region is inadequate to store the CSID in an abnormal case, the incoming CSID must be stored in the second memory region (e.g., the normal data region 331C of FIG. 2) (S230).

Of note, even though the dedicated CSID buffer region is too small to store the received CSID in an abnormal case, the host 200 may nonetheless communicate the CSID to the flash memory 300. That is, consistent with the working examples described in relation to FIGS. 1 and 2, the flash controller 310 may control the flash memory 330 such that the received CSID is stored in a defined second memory region of the flash memory array 331, rather than a first memory region. In this regard, an abnormal case may arise, for example, when a subsequent CS operation is performed before execution of a migration operation associated with an earlier CS operation can be performed, when the incoming CSID is just too large for a dedicated CSID buffer region as currently defined, or when the frequency of CS operations increases.

However, if the size of the remaining memory space in the CSID buffer region is adequate to store the CSID (S214=YES) in a normal case, the flash memory controller 310 will calculate a new remaining CSID buffer region value (Remained_CSIDBufferSize) by subtracting the CSID size value from the current CSID buffer region value (S216). Next, the flash memory may calculate a size value for a written portion of the CSID buffer region currently “in-use” (Written_CSIDBufferSize). As may be understood from the foregoing, a new value for the written portion of the CSID buffer region may be calculated by adding the size of value for the CSID to a current value for the written portion of the CSID buffer region (S218).

The flash memory 330 may now store the CSID in the dedicated CSID buffer region within the first memory region 331B under the control of the flash controller 310 (S220). Then, the host 200 may determine whether the CS operation is complete (S222). If not (S222=No), the method continues as described above until the CS operation is complete.

As described in the context of normal and abnormal cases, when the size of available space in the dedicated CSID buffer region is greater than the size of incoming CSID, the flash controller 310 will control the flash memory 330 in a manner such that the CSID is stored in the dedicated CSID buffer region in the first memory region 331B, else the flash controller 310 will control the flash memory 330 in a manner such that the CSID is stored somewhere other than the designated CSID buffer region, like the normal data region in the second region 331C of the flash memory 330.

In certain embodiments of the inventive concept where the storage device 300 is implemented using an eMMC, the CSID flag may be communicated using the conventionally understood command (CMD23), and CSID may be communicated using the conventionally understood command (CMD25), for example.

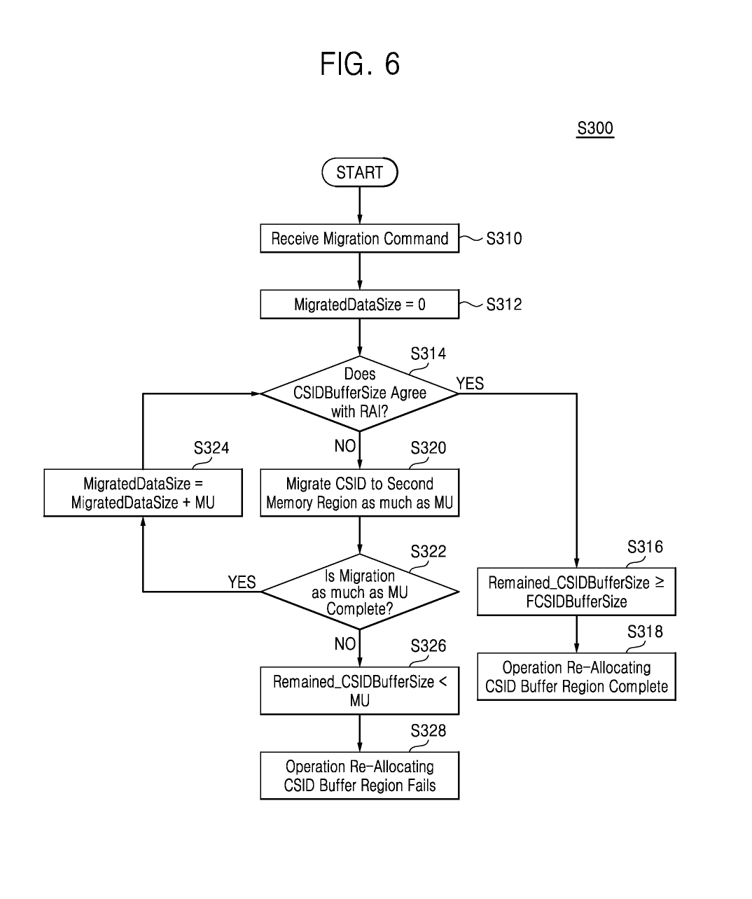

FIG. 6 is a flowchart illustrating one possible operation that may be used to secure (or re-allocate) memory space in a dedicated CSID buffer region during operation of an image processing system like the one shown in FIG. 1. The exemplary re-allocation operation illustrated in FIG. 6 may be performed, for example, during an initialization process for an image processing system, or on-the-fly as multiple CS operations are executed by the image processing system.

Referring to FIGS. 1, 2, 3 and 6, the re-allocation operation essentially initializes (including emptying CSID therefrom) the dedicated region buffer region (CSIDBuffer) in order to maintain acceptable write performance during continuous CS operation of a host device. Thus, it is assumed that multiple, sequentially executed CS operations are performed during a period of continuous shooting by the host 200. Such multiple, sequentially executed CS operations will include corresponding migration commands communicated to the flash storage device 300 (S310). Here, according to a size of a dedicated CSID buffer region as defined by received region allocation information (RAI), the host 200 may adjust timing of migration command generation.

For convenience of explanation, it is assumed that the respective blocks of CSID generated by the sequentially executed CS operations have the same size. Accordingly, the flash controller 310 initiailizes a migrated data unit (MU) size (MigratedDataSize) to ‘0’ upon receipt of the migration command (S312). The flash controller 310 then determines whether the currently allocated size of the dedicated CSID buffer region (CSIDBufferSize) agrees with the received RAI (S314).

When the size of the dedicated CSID buffer region is sufficient to ensure acceptable write performance during CS operations (S314=YES), that is, when the size of the remaining memory space for the dedicated CSID buffer region (Remained_CSIDBufferSize) following execution of a current CS operation is least equal to or greater than the size of memory space in the dedicated CSID buffer region that will remain following execution of a next CS operation (FCSIDBufferSize), then the memory space re-allocation operation for the dedicated CSID buffer region is complete (S318). That is, when the currently remaining size of available memory space in the dedicated CIS buffer region (Remained_CSIDBufferSize) following execution of a current CS operation is at least as great as the size of memory space needed to execute a next CS operation in a sequence of CS operations (FCSIDBufferSize), write performance may be maintained at acceptable levels and no further memory space re-allocation related to the sequence of CS operations need be made at this time.

However, when the size of the dedicated CSID buffer region (CSIDBufferSize) is insufficient to ensure acceptable write performance (S314=NO), that is, when (Remained_CSIDBufferSize) is less than (FCSIDBufferSize) with respect to current and next CS operations directed to the dedicated CSID buffer region and in view of current RAI, then as much as MU worth of the CSID currently stored in the dedicated CSID buffer region may be copied (or “migrated”) from the dedicated CSID buffer region to the second memory region 331C (e.g., a normal data region) so as to increase the size of the remaining available memory space in the dedicated CSID buffer region (i.e., increase Remained_CSIDBufferSize) (S320).

Once CSID migration from the dedicated CSID buffer region is complete (S322=YES), a cumulative size of migrated CSID (MigratedDataSize) is increased by as much as MU according to the actual quantity of CSID copied from the dedicated buffer region (S324).

Steps S314 to S324 in the foregoing re-allocation operation may be repeated until the resulting size of the remaining available memory space in the dedicated CSID buffer region is sufficient to secured acceptable write performance for ongoing CS operations in a sequence of CS operations. In contrast, if it is determined that the size of the remaining memory space in the dedicated CSID buffer region (Remained_CSIDBufferSize) is less than MU (S326), then the re-allocation operation directed to the dedicated CSID buffer region is deemed to fail (S328).

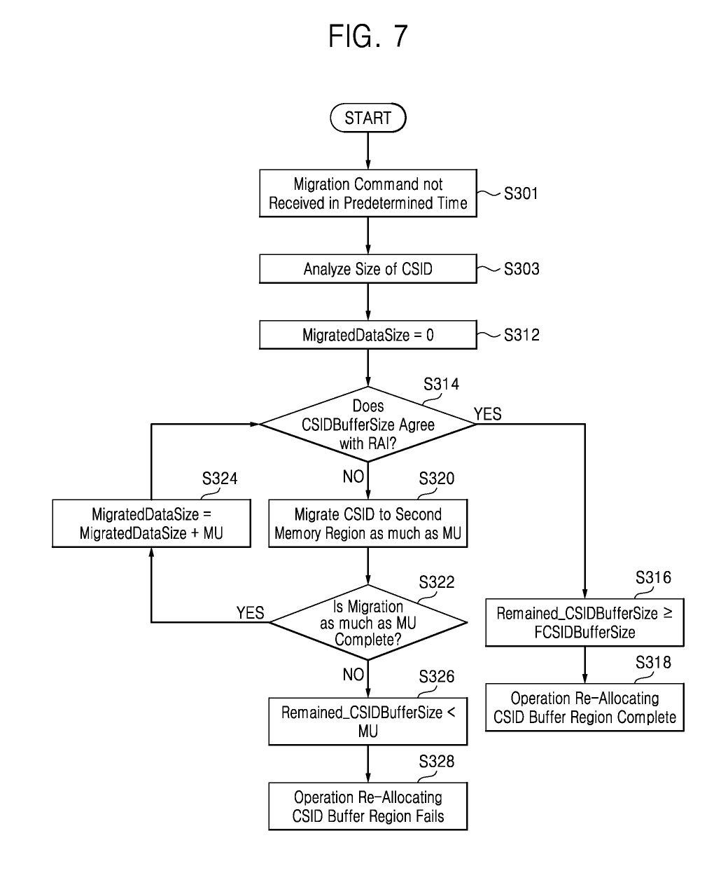

FIG. 7 is a flowchart illustrating another possible operation that may be used to secure (or re-allocate) memory space in a dedicated CSID buffer region during operation of an image processing system like the one shown in FIG. 1.

The method of FIG. 7 is essentially the same as that previously described in FIG. 6, except instead of a migration command (MC) being received within a predetermined time period (S310 in FIG. 6), the method of FIG. 7 assumes that no migration command is received during this established time period (S301), and therefore it is necessary to analyze the size of current CSID (S303) to ensure acceptable write performance. That is, when the host 200 does not communicate a migration command to the flash storage device 300 within a predetermined time (S301), the storage device 300 will analyzes the size of CSID communicated from the host 200 regardless of migration command reception and will then determines whether to perform a migration operation based on a result of this analysis (S303). Thus, when multiple CS operations including a “last CS operation” are performed by the host 200, the CSID provided by the host 200 as the result of the last CS operation and written to the dedicated CSID buffer region may be copied by the storage device 300 to the second memory region even without receiving a migration command within a predetermined time period.

Thus, as described with reference to FIGS. 6 and 7, a migration operation may be performed by the flash storage device 300 in response to a received migration command from the host 200, or in response to the lapse of a predetermined time period following execution of a CS operation.

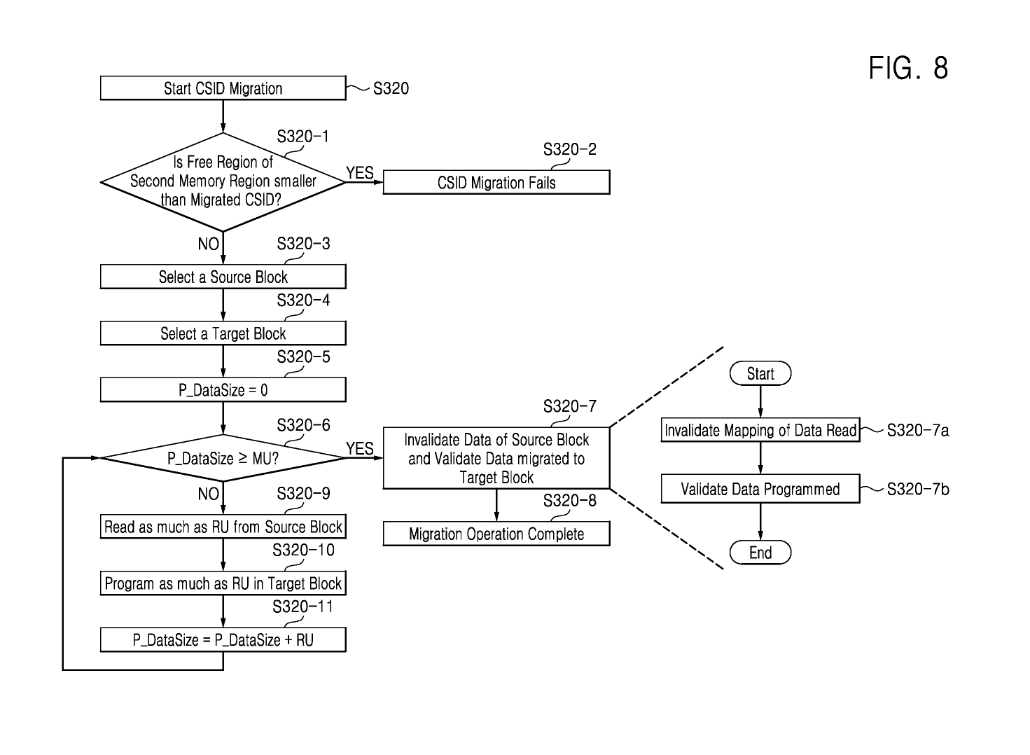

FIG. 8 is a flowchart further illustrating in one possible embodiment the step of migrating the CSID from the dedicated CSID buffer region to the second memory region (S320 of FIGS. 6 and 7).

Referring to FIGS. 6, 7 and 8, so as to increase the size of the remaining available memory space in the dedicated CSID buffer region (Remained_CSIDBufferSize) as much as MU worth of the CSID currently stored in the dedicated CSID buffer region may be migrated out of the dedicated CSID buffer region to the second memory region (S320).

Then, the flash controller 310 may compare the size of the copied CSID with the size of a “free region” (i.e., available memory space) in the second memory region (S320-1). As a result of the comparison, when the size of the migrated CSID is greater than the size of the free region of the second memory region (S320-1=YES), then the CSID migration step (S320 of FIGS. 6 and 7) fails (S320-2).

However, if the size of the copied CSID is smaller than the size of the free region of the second memory region (S320-1=NO), then the flash controller 310 selects a “source block” (e.g., a SLC block) of the dedicated CSID buffer region storing CSID (S320-3), and further selects a “target block” (e.g., a MLC block) of the second memory region to which the copied CSID will be programmed (S320-4)

Assuming that flash controller 310 respectively selects, for example, SLC block 331C-1 and MLC block 331C-2, a size value for data (P_DataSize) programmed in the second memory region may be set to ‘0’ (S320-5).

The flash controller 310 may then compare the size of data (P_DataSize) programmed with the migration unit (MU) (S320-6). When the migration unit MU is greater than the size of data (P_DataSize) programmed, the flash memory 330 reads as much as a read unit (RU) from the source block (S320-9).

Thus, the flash memory 330 may store as much as a read unit's worth in the target block (S320-10). A migration operation, i.e., an operation of migrating or copying as much as the read unit RU from the source block to the target block, includes an internal migration operation using the page buffer 335 or an external migration operation using the RAM 313 included in the flash controller 310, e.g., a SRAM.

The flash controller 310 may increase the size of the data programmed (P_DataSize) by as much as the read unit, and then perform step S320-6 again.

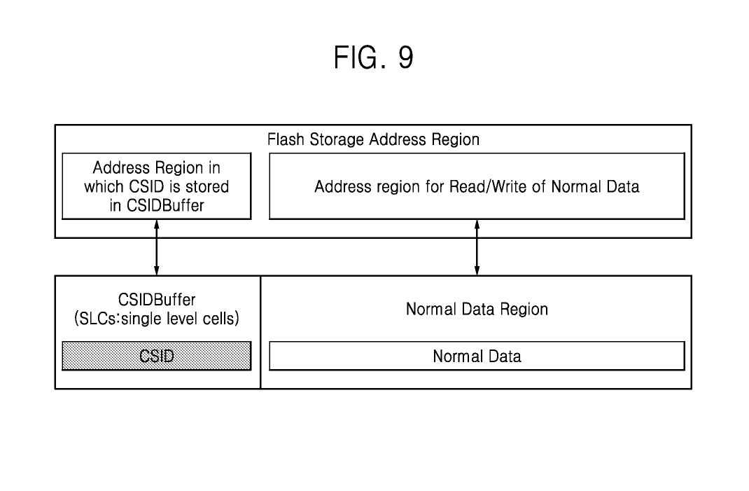

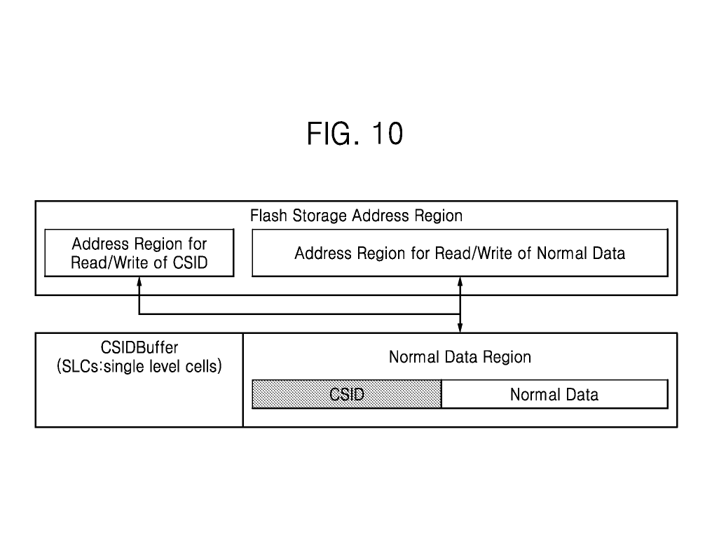

FIGS. 9 and 10 are respective conceptual drawings that further illustrate mapping of addresses after execution of a CS operation according to embodiments of the inventive concept. Referring collectively to FIGS. 8, 9 and 10, when the size of data programmed P_DataSize is equal to or greater than a migration unit MU (S320-6), data of the source block is invalidated and image data migrated to the target block is validated (S320-7).

As illustrated in FIGS. 9 and 10, address mapping of an address region for image data, read as much as the migration unit MU from the source block of the dedicated CSID buffer region in the first memory region 331B, and the source block is invalidated (S320-7a), and address mapping of an address region for image data, stored in the target block of the second memory region 331C as much as the migration unit MU, and the target block is validated (S320-7b).

After the address remapping is finished (S320-7), a portion of the continuous shooting image data CSID, e.g., the migration unit MU, stored in the dedicated region CSIDBuffer of the first memory region 331B is migrated to the second memory region 331C.

Steps S320-1 to S320-8 are performed until all of the CSID stored in the dedicated CSID buffer region of the first memory region 331B has been copied to the second memory region 331C.

Certain methods and an apparatuses for processing continuous shooting image data according to embodiments of the inventive concepts may ensure acceptable write performance while writing high-resolution continuous shooting image data in a storage device regardless of the data storage capacity of a host-provided RAM used to buffer the CSID during continuous CS operations.

Although a few embodiments of the inventive concept have been shown and described, it will be appreciated by those skilled in the art that changes may be made in these embodiments without departing from the scope of the inventive concept as defined in the appended claims and their equivalents.

What is claimed is:

1. A method for operating a flash storage device in an image processing system during execution of multiple continuous shooting (CS) operations that respectively generate CS image data (CSID), wherein a memory array of the flash storage device includes a first memory region and a second memory region, the method comprising:
receiving region allocation information (RAI) from a host;
allocating in response to the RAI a portion of the first memory region as a dedicated CSID buffer region used to temporarily store only CSID during execution of the CS operations; and
allocating a portion of the second memory region as a normal data region used to store normal data during a normal program operation, wherein the first memory region is configured to support data access operations including the normal program operation performed at a first speed, and the second memory region is configured to support data access operations performed at a second speed slower than the first speed.

2. The method of claim 1, wherein the RAI includes a CSID buffer region size value or at least two of an image resolution setting, a CS frame rate, and a CS time.

3. The method of claim 1, wherein the first memory region comprises flash memory cells operated only as single-level memory cells (SLC), the second memory region comprises flash memory cells operated as multi-level memory cells (MLC).

4. The method of claim 1, further comprising storing the RAI in a memory disposed in the host during an initialization operation for the image processing system.

5. The method of claim 1, when the flash storage device is an embedded multimedia card (eMMC) including an extended card specific device (EXT_CSD) register having a VENDOR_SPECIFIC_FIELD field that stores the RAI in response to a SWITCH command received from the host.

6. The method of claim 1, wherein the host includes a processor and a camera module, and the method further comprises for each one of the CS operations:
generating the CSID in the camera module, generating a CSID flag related to the CSID, and providing the CSID and the CSID flag to the processor;
storing the CSID in Random Access Memory (RAM) using the processor; and
programming the CSID in the dedicated CSID buffer region using the processor in response to the RAI and the CSID flag.

7. The method of claim 1, wherein the host includes a processor and a camera module and the flash storage device is an eMMC, and the method further comprises for each one of the CS operations:
generating the CSID in the camera module, generating a CSID flag related to the CSID, and providing the CSID and the CSID flag to the processor;
storing the CSID in Random Access Memory (RAM) using the processor; and
programming the CSID in the dedicated CSID buffer region using the processor in response to the RAI and the CSID flag,
wherein the CSID flag is communicated from the host to the eMMC as a context ID in a command CMD23, and the CSID is communicated from the host to the eMMC as data in a command CMD25.

8. The method of claim 6, further comprising:
after execution of at least one of the CS operations, communicating a migration command from the host to the flash storage device; and
performing a migration operation in response to the migration command that copies a portion of the CSID stored in the dedicated CSID buffer region to the second memory region.

9. The method of claim 8, wherein flash storage device includes a flash controller and a page buffer that in conjunction with the processor control the programming of the CSID in the dedicated CSID buffer region.

10. The method of claim 8, wherein the migration command is communicated from the host to the flash storage device following a predetermined time after execution of a CS operation.

11. The method of claim 1, wherein the host includes a processor and a camera module, and the method further comprises for each one of the CS operations:
generating the CSID in the camera module, generating a CSID flag indicating a size for the CSID, and providing the CSID and the CSID flag to the processor;
storing the CSID in Random Access Memory (RAM) using the processor; and
comparing the size of the CSID with a size of a remaining available memory space in the dedicated CSID buffer region; and
programming the CSID in the dedicated CSID buffer region using the processor in response to the RAI and the CSID flag only when the size of CSID is less than or equal to the size of the remaining available memory space in the dedicated CSID buffer region, else programming the CSID in the second memory region using the processor.

12. The method of claim 11, wherein storing the CSID in the RAM comprises:
buffering the CSID in the RAM and then communicating the CSID from the RAM to the flash memory device on-the-fly during execution of the CS operations.

13. An image processing system comprising:
a host that generates continuous shooting image data (CSID); and
a flash storage device including a memory cell array including a first memory region and a second memory region, wherein a portion of the first memory region is a dedicated CSID buffer region that temporarily stores only CSID, and the second memory region stores normal data provided to the flash storage device by the host during a normal program operation, wherein the first memory region is configured to support data access operations including the normal program operation performed at a first speed, and the second memory region is configured to support data access operations performed at a second speed slower than the first speed.

14. The system of claim 13, wherein the first memory region comprises flash memory cells operated only as single-level memory cells (SLC), the second memory region comprises flash memory cells operated as multi-level memory cells (MLC).

15. The system of claim 14, wherein the host comprises:
a processor;
a camera module that provides the CSID to the processor; and
a Random Access Memory (RAM) that buffers the CSID received from the processor on-the-fly during a sequence of continuous shooting (CS) operations executed by the image processing system.

16. The system of claim 15, wherein the flash storage device comprises a flash controller that defines the dedicated CSID buffer region in the first memory region in response to region allocation information (RAI) received from the processor.

17. The system of claim 16, wherein the processor further provides a CSID flag indicating that data being communicated from the host to the flash storage device is the CSID, wherein the flash controller stores the CSID in the dedicated CSID buffer region in response to the CSID flag.

18. The system of claim 17, wherein the flash controller stores the CSID in the dedicated CSID buffer region only upon first determining that a size of the CSID is less than or equal to a size of remaining available memory space in the dedicated CSID buffer region, else the flash controller stores the CSID in the second memory region.

19. The system of claim 16, wherein the processor further provides a migration command to the flash storage device, and the flash controller in response to the migration command causes a portion of the CSID stored in the dedicated CSID buffer region to be copied to the second memory region.

20. The system of claim 19, wherein the flash controller further causes a portion of the CSID stored in the dedicated CSID buffer region to be copied to the second memory region when a migration command is not received from the host after a predetermined time following execution of a CS operation.

21. The system of claim 20, wherein the host further comprises a flash storage interface controller configured to alternating receive CSID from the processor and directly from the camera module.

22. The system of claim 20, wherein the RAM is a dynamic RAM (DRAM).

23. The system of claim 22, wherein the host and the flash storage device are fabricated on a common substrate using system on chip (SoC) fabrication techniques.
